(19) United States
(12) Patent Application Publication
(10) Pub. No.: US 2002/0062563 A1
(43) Pub. Date: May 30, 2002

(54) METHOD FOR PROCESSING DISCHARGE PORT OF INK JET HEAD, AND METHOD FOR MANUFACTURING INK JET HEAD

(76) Inventors: JUN KOIDE, YOKOHAMA-SHI (JP); TOSHINORI HASEGAWA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/339,869

(22) Filed: Jun. 25, 1999

(30) Foreign Application Priority Data
Jun. 29, 1998 (JP) 10-182407
May 12, 1999 (JP) 11-130738
May 12, 1999 (JP) 11-130752
May 12, 1999 (JP) 11-130790

(51) Int. Cl. B23P 17/00; H04R 17/00; B23K 26/00

(52) U.S. Cl. 29/890.1; 29/25.35; 219/121.6

(57) ABSTRACT

A method for processing the discharge port of an ink jet head provided with discharge port for discharging ink and a discharge port plate having the discharge port, comprising the following steps of closely contacting the mask plate having opening in the form of the discharge port with the face of the discharge port plate on the ink discharge side; and forming the discharge port on the discharge port plate by irradiating plural high energy ultraviolet parallel beams simultaneously through the mask plate in the direction inclined at a specific angle to the vertical axis of the mask plate face. With the method thus arranged, the aperture diameters on the ink discharge side can be made uniform, and the tapered configuration becoming thinner toward the ink discharge side can also be formed reliably, hence making it possible to stabilize the discharge direction of ink droplets, and enhance the flying speed of discharged ink for the performance of high quality printing with each clear dot having an extremely small amount of mist.

### BACKGROUND OF THE INVENTION

1. Field of the Invention

The present invention relates to a method which uses the ultraviolet rays to perform the sublimation processing the discharge ports of an ink jet head, through which ink droplets are discharged to fly for the adhesion thereof to a recording medium. The invention also relates to a method for manufacturing an ink jet head.

2. Related Background Art

The print quality of an ink jet printer largely depends on the ink discharge characteristics of the discharge ports which are the part through which ink is discharged. The discharge characteristics of the discharge ports are determined substantially by the diameter of each discharge port and the configuration thereof. As the method for forming the discharge ports, there are roughly two kinds. It has been proposed as one of them to form the discharge ports by means of electroforming or electric discharging which uses metallic plates, and, as the other one of them, to process the discharge ports by the application of the high energy laser, such as the ultraviolet laser represented by the excimer layer, to execute the sublimation process on a material such as an organic polymer resin. At present, it is generally practiced to perform the fine processing by the application of the ultraviolet laser.

Conventionally, when the ablation process is executed with the preferable laser energy concentration in order to ablate the organic polymer resin or the like, the processed area is gradually reduced from the incident side to the exit side of the irradiation of laser, thus presenting the so-called tapered configuration after process. Here, since the tapered configuration of the discharge port should be the one that has thinner leading end on the ink discharge side, which is required to enhance the print quality of an ink jet head, it is practiced to irradiate laser from the ink supply side (from the ink flow path side of the discharge port plate) when the laser processing is executed as disclosed in the specification of Japanese Patent Laid-Open Application No. 2-187346, for example.

However, for the laser processing as described above, it is known that the tapered condition is subjected to changes by the applied laser power. Also, with the required length of the discharge port which is approximately 10 μm to 100 μm in consideration of the print quality, the thickness of the discharge port plate needs to be arranged accordingly as a matter of course. Therefore, when the discharge ports are formed by the method described above, the discharge port diameter on the ink discharge side (the laser exit side) tends to be varied by each individual head eventually. As a result, with the discharge port diameter thus varied, the ink jet head having a plurality of discharge ports, in particular, or an ink jet printer having a plurality of heads mounted on it makes it necessary to carry out discharge inspections after the completion of each head so that the information of its discharge characteristics should be kept for the correction of each head.

In contrast, if the laser beam is irradiated from the ink discharge side, the influence of varied laser power is not easily exerted on the discharge port diameter on the ink discharge side. In this case, however, the discharge port configuration becomes such that it is made wider on the ink discharge side.

Now, therefore, the following methods have been proposed for forming the discharge ports with a view to solving such problems as discussed above.

One of them is the method proposed in Japanese Patent Application Laid-open No. 6-510958 (International Patent Application Laid-open No. W093/12937) (Compaq Computer Corporation) in which the light beams each constrained by use of a mask pattern are diagonally incident in the two directions on the discharge port plate. With the diagonally incident light beams, the plate is processed in the progressing direction thereof. As a result, the tapered configuration is formed on the discharge port plate with the wider processed width on the inner side than the outer side.

The other one of them is the method proposed in Japanese Patent Publication No. 6-24874 (Xaar Limited) in which the light beam is irradiated on the mask plate having the nozzle pattern formed on it, which is closely in contact with the discharge port plate, and then, the mask plate and the discharge plate which are closely in contact are allowed to be relatively oscillated or pivotally rotated so that the light beam is diagonally incident upon them. As a result, with the advancement of the process by the light beam in the incident direction, the discharge ports are formed with the thinner leading end on the outer side of the discharge port plate.

However, in accordance with the structure disclosed in the specification of Japanese Patent Application Laid-open No. 6-510958, the light beams are irradiated in the two directions so as to intersect on the discharge port plate. As a result, there is a fear that the discharge port diameters are varied on the ink discharge side depending on the positions of the light beams. Also, there is a significant disadvantage in terms of productivity, because its process time becomes very long if an extremely large number of discharge ports should be arranged. Here, this method does not adopt the projection focusing system of the mask patterns. As a result, each of the discharge ports should be processed individually one by one.

Meanwhile, in accordance with the structure disclosed in the specification of Japanese Patent Publication No. 6-24874, the mask plate and the discharge port plate should be motioned to be inclined to the light beam as the time elapses. Therefore, it becomes difficult to process the symmetrically tapered configuration with respect to the axial direction of the ink discharge depending on the states of the process at the time of initiation and termination, that is, by the time that elapses in the process of the machining operation. As a result, the drawback is encountered in each of the ink jet heads that the uniform flight of discharged ink becomes difficult. In addition, although the entire mask pattern (a large number of arranged discharge ports) can be processed at a time, it takes a long time to complete processing, because the processing time is restrained by the time required for the motional operation needed to incline the mask plate and the discharge port plate with respect to the light beam as the time elapses. A control of the kind thus needed presents a disadvantage of this method in terms of the productivity.

### SUMMARY OF THE INVENTION

The present invention is designed in consideration of the problems discussed above. It is an object of the invention to provide a method for forming the tapered configuration having the thinner leading end as a whole, which is symmetrical in the axial direction of ink discharges and laser processed from the outer side (ink discharge side) of the discharge port plate, as well as to provide a method for processing a large number of arranged discharge ports altogether as arranged in a shorter period of time.

In order to achieve the objectives described above, the method of the present invention for processing the discharge ports of an ink jet head provided with discharge ports for discharging ink and a discharge port plate having the discharge ports, comprising the following steps of closely contacting the mask plate having opening in the form of the discharge ports with the face of the discharge port plate on the ink discharge side; and forming the discharge ports on the discharge port plate by irradiating plural high energy ultraviolet parallel beams simultaneously through the mask plate in the direction inclined at a specific angle to the vertical axis of the mask plate face.

With the structure thus arranged, the aperture diameters on the ink discharge side can be made uniform, and the tapered configuration becoming thinner toward the ink discharge side can also be formed. Thus, the discharge direction of ink droplets is stabilized, and the flying speed of discharged ink is also enhanced.

Further, the closely contacted mask plate and discharge plate are arranged to rotate around the overall central axis (optical axis) of the irradiated plural ultraviolet parallel beams with this over all central axis as the rotational axis thereof. In this manner, it becomes possible to process the discharge ports in a spiral form. As a result, the liquid droplets of the recording liquid are provided with the rotational component turning around the axis of the flying direction with respect to the flying direction thereof, hence making it possible to stabilize its advancement and flight by this rotational inertia, and to prevent the generation of mists.

Here, each of the discharge ports is provided in the spirally tapered configuration becoming thinner on the liquid discharge side (outer side) of the discharge plate to make it possible to stabilize the discharge direction of liquid droplets in a specific direction, as well as to enhance the flying speed of the discharged recording liquid. As a result, the images are obtainable in high quality having each of the printed dots in a clear circle with an extremely small amount of mist. Also, the ink jet head thus manufactured is able to enhance its printing quality and speed significantly.

Also, on the outer face of the discharge port plate, a sacrificing layer, such as formed by a membrane or film processible by the laser to be irradiated, is arranged to be in close contact, and then, the discharge ports are processed by ablation on the discharge port plate. After the processing, the sacrificing layer is peeled to be removed chemically or physically. In this way, it is made possible to each ink discharge edge of the discharge ports is made sharper on the outer side of the discharge port plate. Also, in this manner, it becomes possible to prevent the water repellent layer from being damaged on the outer side of the discharge port plate, and protect this layer. Also, with the provision of the sacrificing layers both on the inner face of the discharge port plate and on the ink flow path wall face at the same time, which are removed after the processing, it becomes possible to prevent the interior of the ink jet head from being contaminated by the presence of debris, the by-products of the processing.

With the processing method thus arranged, it becomes possible to form the discharge ports in the last assembling step of an ink jet head, and eliminate the non-uniformity of the discharge port orientation that may be caused by the deformation of the discharge port plate at the time of assembling bonding operation. Further, with the tapered configuration which becomes thinner locally or entirely on the outer side of the discharge port plate (ink discharge side), as well as with the formation of the sharper edge of each discharge port, ink can be cut in a better condition when it is discharged, hence more reliably preventing ink from being twisted in its discharge direction due to its own surface tension. At the same time, the generation of mist becomes almost none when ink is cut. As a result, the print quality is significantly enhanced with the specifically stabilized direction of ink droplet discharges. The flying speed of discharge ink is also improved for the provision of the higher print quality, and higher speed printing as well.

Also, the closely contacted mask plate and discharge port plate are arranged to perform one or more reciprocative scannings on the irradiating area of the high energy ultraviolet beams along the arrangement that forms the discharge ports, hence making it possible to irradiate the ultraviolet beam onto each of the discharge ports under the same condition obtainable by the integrated effect which is thus produced on the uneven irradiation of the ultraviolet beams. As a result, all the discharge ports are configured uniformly to enable the droplets of liquid ink to fly exactly and stably for the performance of high quality printing.

Also, with the implementation of the processing method for forming all the discharge ports in the tapered configuration becoming thinner toward the ink discharge side, the discharge direction of ink liquid droplets is stabilized at a specific direction with the enhanced flying speed of the discharged ink. As a result, the images are obtainable in high quality having each of the printed dots in a clear circle with an extremely small amount of mist. Also, the ink jet head thus manufactured is able to enhance its printing quality and speed significantly.

### BRIEF DESCRIPTION OF THE DRAWINGS

FIGS. 1A, 1B and 1C are views which schematically illustrate a method for processing the discharge ports of an ink jet head in accordance with a first embodiment of the present invention;

FIG. 2 is a view which shows the coordinate system of the ink jet head in accordance with the present invention;

FIG. 3 is a view which illustrates the laser irradiation directions of the method for processing the discharge ports of the ink jet head in accordance with the first embodiment of the present invention;

FIGS. 4A, 4B and 4C are views which schematically illustrate the ink jet head manufactured by the method for manufacturing an ink jet head in accordance with a first embodiment of the present invention;

FIG. 5 is a perspective view which shows a discharge port of the ink jet head manufactured by the method for manufacturing an ink jet head in accordance with the first embodiment of the present invention;

FIGS. 6A and 6B are views which schematically illustrate the method for processing the discharge ports of an ink jet head in accordance with a second embodiment of the present invention;

FIGS. 7A, 7B and 7C are views which schematically illustrate the ink jet head manufactured by the method for manufacturing an ink jet head in accordance with the second embodiment of the present invention;

FIG. 8 is a perspective view which shows a discharge port of the ink jet head manufactured by the method for manufacturing an ink jet head in accordance with the second embodiment of the present invention;

FIG. 9 is a view which schematically shows the optical system of an apparatus for processing the discharge ports of the ink jet head in accordance with the first embodiment of the present invention;

FIG. 10 is a view which schematically shows the introduced beam bymeans of the pyramid prism in accordance with the first embodiment of the present invention;

FIG. 11 is a view which schematically shows the optical system of the apparatus for processing the discharge ports of the ink jet head in accordance with the second embodiment of the present invention;

FIGS. 12A, 12B and 12C are views which schematically illustrate the method for processing the discharge ports of an ink jet head in accordance with a third embodiment of the present invention: FIG. 12A is a front view; FIG. 12B, a side view; and FIG. 12C, a bottom view;

FIG. 13 is a perspective view which shows a discharge port of the ink jet head manufactured by the method for manufacturing an ink jet head in accordance with the third embodiment of the present invention;

FIG. 14 is a view which schematically shows the method for processing the discharge ports of an ink jet head in accordance with a fourth embodiment of the present invention;

FIGS. 15A and 15B are views which illustrate the edge formation process of a discharge port of the ink jet head in accordance with a fourth embodiment of the present invention;

FIGS. 16A and 16B are views which illustrate the removal of the processed by-products of the discharge ports of the ink jet head in accordance with the fourth embodiment of the present invention;

FIG. 17 is a view which shows the removal of the processed by-products in the ink flow path of the ink jet head in accordance with the fourth embodiment of the present invention;

FIGS. 18A, 18B and 18C are views which schematically illustrate the method for processing the discharge ports of the ink jet head in accordance with a fifth embodiment of the present invention; and

FIGS. 19A, 19B, 19C, 19D and 19E are views which illustrate the process of the method for processing the discharge ports of the ink jet head in accordance with the fifth embodiment of the present invention.

### DETAILED DESCRIPTION OF THE PREFERRED EMBODIMENTS

Hereinafter, with reference to the accompanying drawings, the description will be made of the embodiments in accordance with the present invention.

(First Embodiment)

Now, hereunder, the detailed description will be made of a method for processing discharge ports in accordance with the present embodiment, which is the principle part of the present invention.

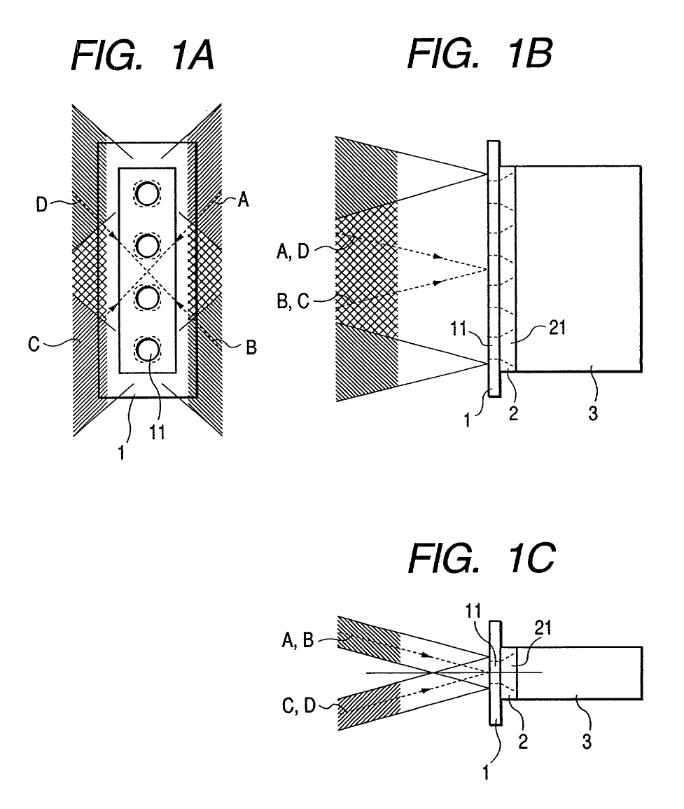

FIGS. 1A to 1C are views which schematically illustrate the method for processing the discharge ports of an ink jet head in accordance with the present embodiment.

In FIGS. 1A to 1C, the discharge ports 21 are formed by the irradiation of the ultraviolet laser beams A, B, C, and D from the ink discharge side onto the discharge port plate 2 bonded to be assembled in the ink jet head main body 3 (hereinafter referred to as a discharge port plate). The laser beams A, B, C, and D are inclined, respectively, in the different directions to the vertical line of the mask plate 1 with the opening of the discharge port pattern 11, which is closely in contact with the discharge port plate 2 in advance. The overlapping positions of the laser beams A, B, C, and D are specified on the mask plate 1 portion. As a result, the discharge port diameter at the end portion on the ink discharge side is univocally determined by the aperture diameter of the mask plate in accordance with the present invention. There is no influence that may be exerted by the fluctuation of the laser power, hence making it possible to form the discharge port diameter on the end portion of the ink discharge side uniformly.

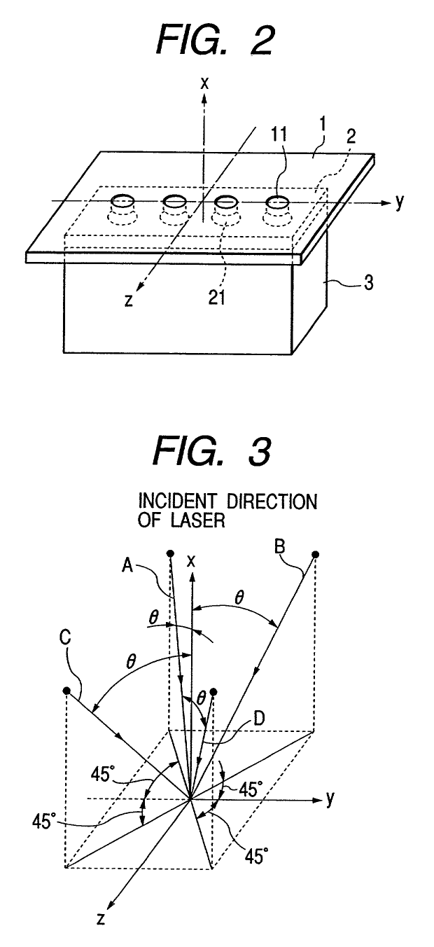

In this respect, the detailed description will be made of each direction of the laser beams A, B, C, and D irradiated to the mask plate. Now, given the xyz coordinate system set as shown in FIG. 2, each of the laser beams forms an angle of 45° (90° to each of the laser beams themselves) to the axis y (the arrangement direction of the discharge ports 21) in the plane projection of y and z, and each of them is irradiated in the direction that forms the same inclination angle θ to the axis x (in the vertical direction of the mask plate 1), that is, in the directions shown in FIG. 3. Here, the θ is set at an angle of approximately 5° to 20°, although the angle is set depending on the thickness of the discharge port plate 2 to be processed, as well as on the energy concentration of the laser beams to be applied when the angle is designed. In accordance with the present embodiment, this angle is set at 13°.

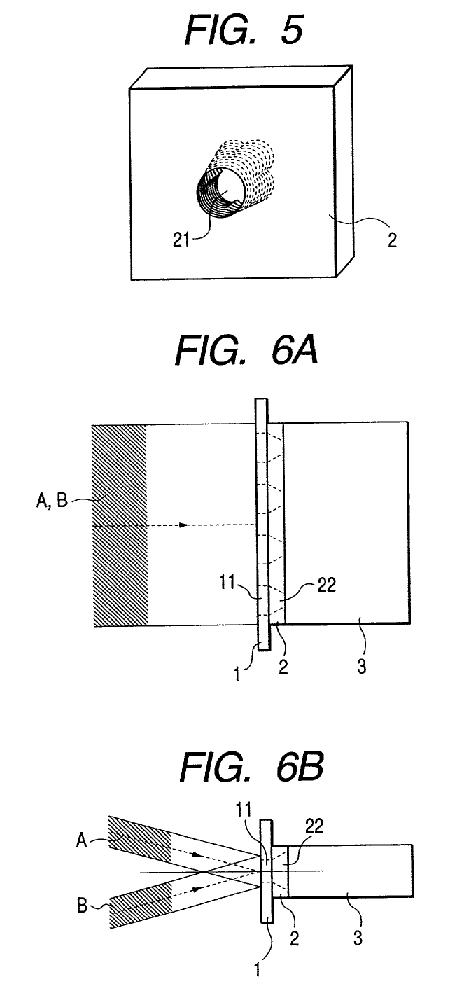

The discharge port 21 thus processed is not in the conical form cut in the rotation symmetry, but as shown in FIG. 5, it is configured to be conical on the ink discharge side (on the front side in FIG. 5) and almost square formed by the four circles overlaid radially on the ink supply side (in the depth side in FIG. 5) due to the laser irradiation process in the axially symmetrical directions with respect to the four axes x. Then, the configuration is made in which the circular form gradually changes substantially to the square form in the thickness direction of the discharge port plate 2.

In this way, in accordance with the present embodiment, the parallel beams A, B, C, and D of the ultraviolet laser are irradiated in the four directions at the same time to perform the ablation process in the advancing direction of each laser beam in the thickness direction of the discharge port plate 2, hence forming a plurality of discharge ports 21 each having the tapered configuration that becomes thinner at the leading end in the ink discharge direction (the mask plate side).

Now, with reference to FIG. 9, the description will be made of one example of the optical system used for the implementation of the discharge port processing as described above, in which the parallel beams A, B, C, and D of the ultraviolet laser are irradiated simultaneously in the four directions inclined to the vertical line of the mask plate 1.

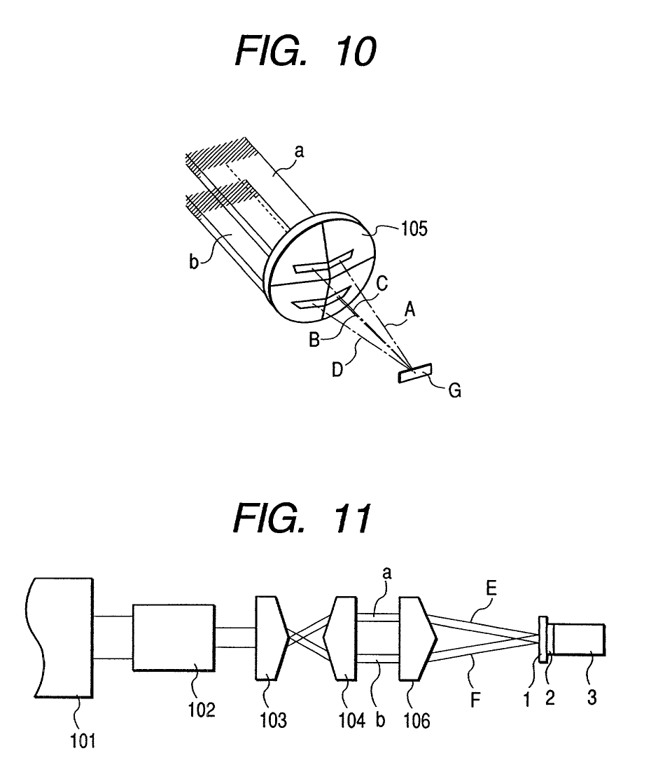

The laser beams, which are discharged from the excimer laser oscillator 101 that discharges the parallel beams of the ultraviolet laser, are shaped and converted by the beam compressor 102 into the size of a specific sectional configuration. Then, the laser beams are introduced into the first prism 103 to be divided into the beams having two different exit angles through the area that includes the vertical angle. After that, the two divided beams are converted into the parallel advancing beams a and b by means of the second prism 104 having the same shape as the prism 103, which is positioned to enable the vertical angles thereof to face each other. The beams a and b are incident upon the third prism 105 in the form of a pyramid having four inclined faces. Then, as shown in FIG. 10, each of the beams A, B, C, and D is introduced by the inclined faces having the four axially symmetrical inclined angels into the area at G where the beams are overlaid at the same angle to the central axis (the optical axis). Also, the four overlaid laser beams in the area G are adjusted by the gap between the prism 103 and the prism 104. In other words, the laser beams are irradiated at the same deflection angle in the four axially symmetrical directions with respect to the vertical axis of the mask plate 1.

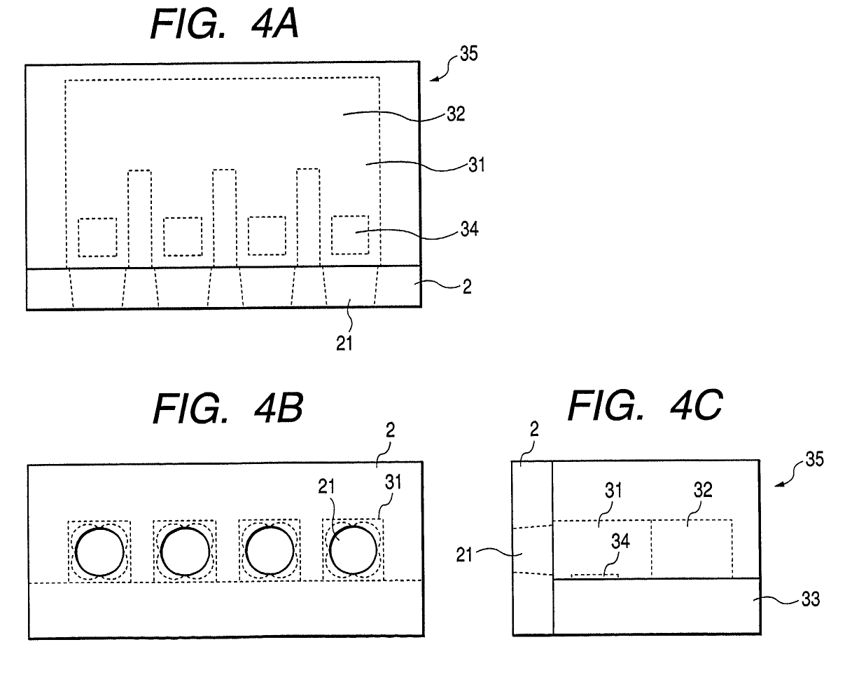

Now, with reference to FIGS. 4A to 4C, the description will be made of the ink jet head to which the aforesaid method for processing the discharge ports is applicable.

In FIGS. 4A to 4C, a reference numeral 33 designates the substrate. On this substrate, there are arranged ink discharge pressure generating elements 34 for discharging ink, such as the electrothermal transducing devices, the electromechanical transducing devices, among some others. Each of the ink discharge pressure generating elements 34 is arranged in each of the ink flow paths 31 communicated with each discharge port 21. Each of the ink flow paths 31 is communicated with the common liquid chamber 32. An ink supply tube (not shown) is connected with the common liquid chamber 32, and ink is supplied from an ink tank through the ink supply tube. Also, a reference numeral 35 designates the ceiling plate having the recessed portions to form the ink flow paths 31 and the common liquid chamber 32, which is bonded to the substrate 33 to form the ink flow paths 31 and the common liquid chamber 32. Further, the discharge port plate 2, which is provided with the discharge ports 21, is arranged for the integrated body of the substrate 33 and the ceiling plate 35 on the ink flow path end portion side. Also, the arrangement of the discharge ports 21 formed on the discharge port plate 2 may be arbitrarily made, such as plural numbers in one dimensional arrangement or plural numbers in plural lines.

An ink jet head of the kind can be produced as given below.

In other words, at first, the substrate 33 is produced by patterning on the silicon substrate the heaters 34 which are the heat generating resistors for use of the ink discharge pressure generation, the shift registers and other integrated circuits (not shown), and the electric wiring, and at the same time, the ceiling plate 3 is produced by forming the recessed portion that becomes the ink flow paths 31 and the ink liquid chamber 32, and the ink supply port as well, on the silicon plate by means of the chemical etching. Then, the substrate 33 and the ceiling plate 35 is aligned so as to arrange the end face on the ink discharge side, the ink flow paths 31, and the heaters 34 to be in agreement. After that, the discharge port plate 2 whose discharge ports are yet to be formed is adhesively bonded to the end face on the ink discharge side of the bonded body of the ceiling plate 35 and the substrate 33. In this state, the discharge ports 21 are formed by means of the discharge port processing described above. Thereafter, the electric board having the terminals (not shown) patterned for use of heat driving thereon is bonded, and then, the aluminum base plate is connected with the substrate 33. Subsequently, the holder that holds each of the members and the ink tank, from which ink is supplied, are connected to assemble the ink jet head.

Also, the ceiling plate 35 having the recessed portion that becomes ink flow paths 31 and the ink liquid chamber 32, and the ink supply port formed thereon, and the discharge port plate 2 in the state where the discharge ports are yet to be formed, are arranged to be integrally molded by means of injection molding using polysulfone or some other resin material. The structure thus arranged is bonded to the substrate 33 having the integrated circuit silicon chip mounted thereon with the patterned heaters 34 after alignment. Then, by means of the aforesaid method for processing the discharge ports, the discharge ports 21 are formed. Thereafter, the electric board having the terminals (not shown) patterned for use of heat driving thereon is bonded, and then, the aluminum base plate is connected with the substrate 33. Subsequently, the holder that holds each of the members and the ink tank, from which ink is supplied, may also be connected to assemble the ink jet head.

Here, in accordance with the present invention, it is preferable to execute the processing of the discharge ports in the processing step after the discharge port plate, which forms the discharge ports, is bonded to the member that holds this plate member, irrespective of the structure of an ink jet head to be manufactured. With the ink jet head thus manufactured, it becomes possible to prevent the ink discharge direction from being fluctuated due to the deformation that may take place in the discharge port arrangement or due to the deviated orientation of discharge ports that presents ununiformal discharge directions when the discharge port plate is bonded to the holding member, which may be accompanied by distortion.

Also, in accordance with the present embodiment, the configuration of each discharge port 21 of the discharge port plate 2 on the ink supply side is substantially square to make it possible to form the sectional area of the ink flow path also square in the ink flow direction. Here, the discharge ports 21 are laser processed to form them to fit into each other to make ink flow path configuration smoothly continuous. In this manner, the flow resistance to ink liquid is reduced to make the flying speed of ink faster, hence demonstrating the effect that the quality of the ink jet head is enhanced, such as to provide the higher speed of printing. Therefore, it is desirable to irradiate laser in the direction from the vertical angle of the ink flow path section on the Y-Z plane if the sectional configuration of the ink flow path is rectangular.

For the present embodiment, the polysulfone discharge port plate in a thickness of 50 μm is bonded to the ink jet head main body. After that, the mask plate having 150 apertures of 20 μm Φ each arranged in a density of 300 dpi is placed closely with the discharge port plate. Then, using the aforesaid optical system the four parallel beams of excimer laser are irradiated with the laser power of 1 J/cm² to form the discharge ports. Also, the inclination angle at that time is arranged to be 13° to the axial direction of ink discharges. 50 pieces of the head are produced in order to observe the configuration of the discharge ports. Everyone of them has a tapered configuration having the thinner leading end on the ink discharge side. Also, the fluctuation of the aperture diameter of each of the discharge ports on the ink discharge side is made significantly smaller than the conventional ones.

Also, the actual printing is performed with the ink jet heads thus manufactured. Then, images are obtained with excellent print quality.

(Second Embodiment)

In accordance with the first embodiment, the discharge ports are processed by use of the four parallel beams. For the present embodiment, however, the structure is arranged to process the discharge ports by use of the two parallel beams.

As shown in FIGS. 6A and 6B, the second embodiment of the method for processing the discharge ports of an ink jet head in accordance with the present invention is such that the mask plate 1 having the opening of the discharge port pattern 11 is arranged to be closely in contact with the ink jet head in advance in a state where the discharge port plate 2 is assembled and bonded thereto, and that the parallel beams a and b of the ultraviolet laser are irradiated simultaneously onto the ink jet head main body 3 in the two directions inclined to the vertical line of the mask plate 1. Thus, a plurality of discharge ports 22 are formed at a time, each having the tapered configuration which is made thinner locally in the ink discharge direction (on the mask plate side), by means of the ablation process in the advancing direction of each of the laser beams in the thickness direction of the discharge port plate 2 formed by the organic polymer resin material.

The irradiating direction of each of the laser beams a and b toward the mask plate is perpendicular to the arrangement direction of the discharge ports 22, and the irradiation is given in the direction so as to make it at the same angle with respect to the vertical direction of the mask plate 1.

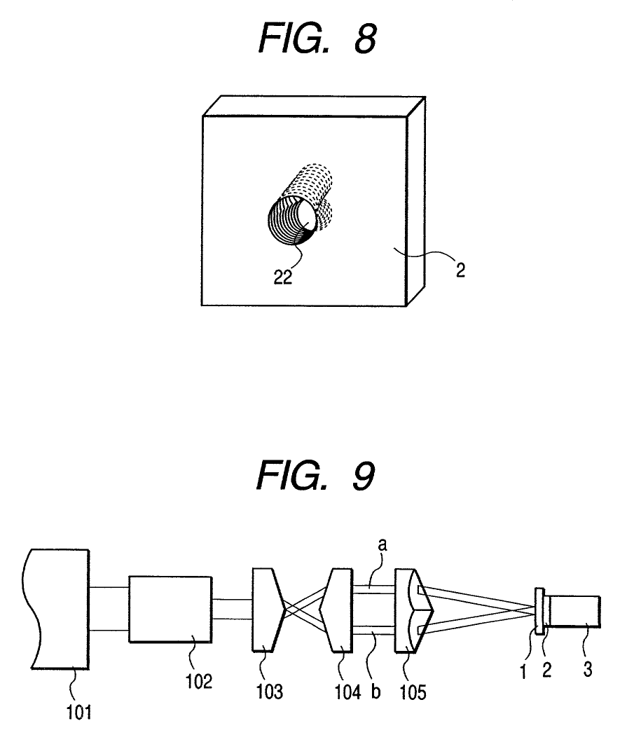

The configuration of each discharge port 22 thus processed is not conical cut in the rotation symmetry. As shown in FIG. 8, it is circular on the ink discharge side (on the front side in FIG. 8), but it is gourd shaped on the ink supply side (on the depth side in FIG. 8), because of the laser irradiation process in the two directions. Thus, in the thickness direction of the discharge plate 2, the configuration presents the gradual changes from the circular form to the gourd shaped form.

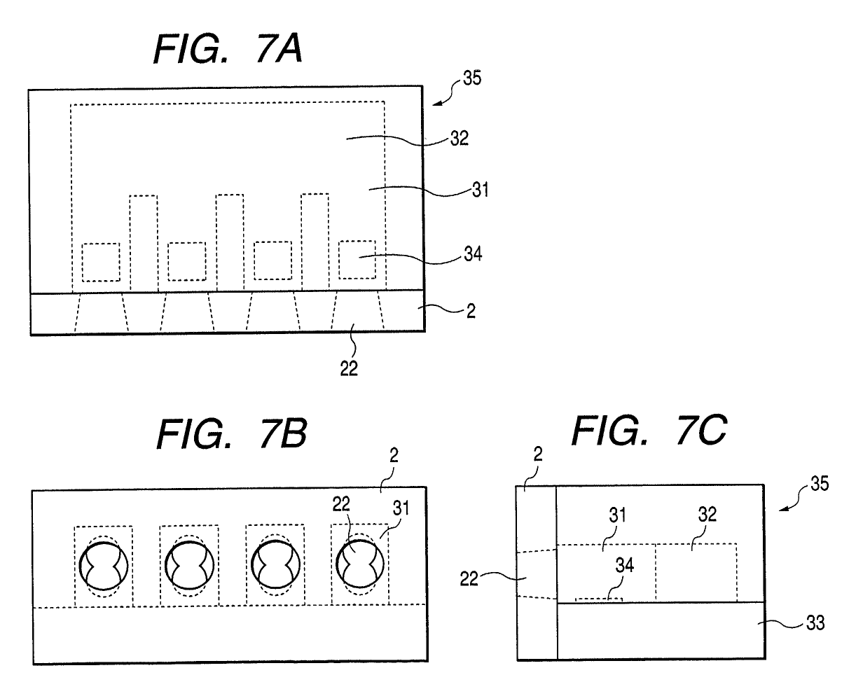

Also, as shown in FIGS. 7A to 7C, each of the discharge ports 22 of the discharge port plate 2 on the ink supply side is configured to be in an elongated gourd-shaped form, and the sectional area of each ink flow path is rectangular in the ink flow direction. Thus, each of the discharge ports 22 is laser processed in an configuration to allow them to fit into each other. Here, if there is a need for a larger area of each discharge port, and further, the arrangement of discharge ports should be highly densified in order to make amount of ink discharge greater, the present embodiment presents an advantage that it is possible to arrange the configurations of the discharge ports and ink flow paths to allow them to be smoothly continued.

Now, with reference to FIG. 11, the description will be made of the optical system for irradiating the parallel beams A and B of the ultraviolet layer in the two directions inclined to the vertical line of the mask plate 1, which is used for the implementation of the discharge port processing described above.

The laser beams, which are discharged from the excimer laser oscillator 101 that discharges the parallel beams of the ultraviolet laser, are shaped by the beam compressor 102 to be converted into the beam having the size of the specific sectional area, and introduced into the first prism 103 to separate them by the area that includes the prism vertical angle into two beams having different exit angles. After that, the two divided beams are converted into the parallel advancing beams a and b by means of the second prism having the same shape as the prism 103, which is positioned to enable the vertical angles thereof to face each other. The beams a and b are incident upon the third prism 106 in the form of a pyramid having two inclined faces. Then, each of the beams E and F is introduced by the inclined faces having the two axially symmetrical inclined angels into the mask plate 1 where the beams are overlaid at the same angle to the central axis (the optical axis). In other words, the laser beams are irradiated at the same deflection angle in the two axially symmetrical directions with respect to the vertical axis of the mask plate 1.

For the present embodiment, too, the ink jet heads are produced in the same manner as the first embodiment with the exception of the parallel beams which are arranged to be two.

In accordance with the present embodiment, too, it becomes possible to reduce the fluctuation of the aperture diameter significantly for each of the discharge ports as compared with the conventional ones on the end portion on the ink discharge side.

(Third Embodiment)

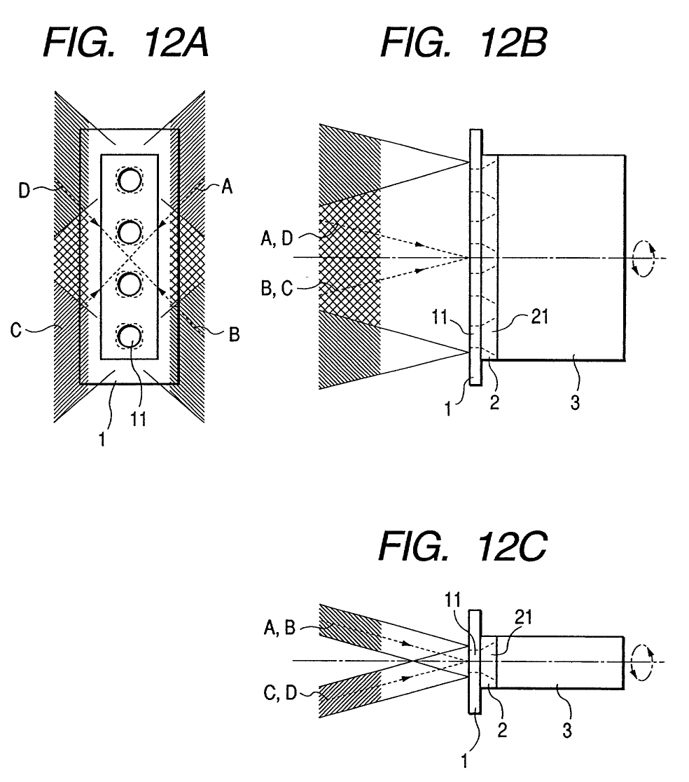

With reference to FIGS. 12A to 12C, of a third embodiment will be described.

FIGS. 12A to 12C are views which schematically illustrate the method for processing the discharge ports of an ink jet head in accordance with the third embodiment of the present invention. The detailed description will be given below as to the method thereof.

In FIGS. 12A to 12C, a reference numeral 1 designates the mask plate having the pattern 11 is open for processing the discharge ports to be formed; 2, the discharge port plate for the discharge ports 21 to be formed (hereinafter referred to as the discharge plate); 3, the ink jet head main body to which the discharge port plate 2 is bonded. Each of the discharge ports 21 is processed and formed by the irradiation of the ultraviolet beams A, B, C, and D from the liquid discharge side onto the discharge port plate 2 which has been bonded and assembled with the ink jet head main body 3. The laser beams A, B, C, and D are each inclined in the different directions to the vertical line of the mask plate 1 which is closely in contact with the discharge port plate 2 in advance. Then, the position where the laser beams A, B, C, and D are overlaid is fixed on the patterned portion of the mask plate 1. Therefore, in accordance with the present invention, the diameter of each discharge port on the end portion of the liquid discharge side, which is to be processed, is univocally determined by the aperture diameter of the mask plate 1. There is no possibility that it is affected by the fluctuation of the applied laser power, hence making it possible to form the uniform diameter for each of the discharge ports on the end portion on the liquid discharge side.

In this respect, the detailed description will be made of each direction of the laser beams A, B, C, and D irradiated to the mask plate 1. Now, given the xyz coordinate system set as shown in FIG. 2, each of the laser beams forms an angle of 45° (90° to each of the laser beams themselves) to the axis y (the arrangement direction of the discharge ports 21) in the plane projection of y and z, which is defined as the standard condition, and each of them is irradiated in the direction that forms the same inclination angle θ to the axis x (in the vertical direction of the mask plate 1), that is, in the directions shown in FIG. 3. Here, the θ is set at an angle of approximately 5° to 20°, although the angle is set depending on the thickness of the discharge port plate 2 to be processed, as well as on the energy concentration of the laser beams to be applied when the angle is designed. In accordance with the present embodiment, this angle is set at 13°.

Then, the closely contacted mask plate 1, discharge port plate 2, and ink jet head main body 3 are rotated in a small circle or in a small circular in the directions indicated by arrows in FIGS. 12A to 12C around the overall central axis (the optical axis) as the rotation axis during the period from the initiation to the termination of the processing. In this manner, the discharge ports 21 are processed in the spiral form. Here, also, there is no need for the projection of each laser beam onto the yz plane to be in an angle of 45° (90° to each of the laser beams themselves) with respect to the axis y (the arrangement direction of the discharge ports 21) in the initiating state of the processing. It may be possible to initiate the processing in a specific state depending on the processing conditions.

In this way, the parallel beams A, B, C, and D of the ultraviolet laser are irradiated in the four directions at the same time to perform the ablation process in the advancing direction of each laser beam in the thickness direction of the discharge port plate 2, hence forming a plurality of discharge ports 21 each having the spirally tapered configuration that becomes thinner at the leading end in the ink discharge direction (the mask plate side) with the rotation of the closely contacted mask plate 1, discharge plate 2, and ink jet head main body 3 around the overall central axis (the optical axis) of the plural ultraviolet beams as the rotational axis thereof.

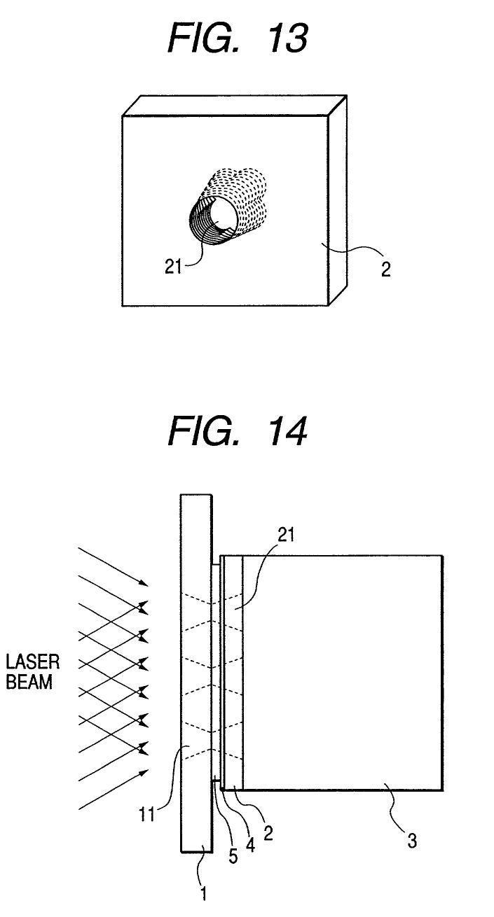

Each of the discharge ports 21 thus processed is not in the conical form cut in the rotation symmetry, but as shown in FIG. 13, it is configured to be conical on the recording liquid discharge side (on the front side in FIG. 13) and almost square formed by the four circles overlaid radially on the recording liquid supply side (in the depth side in FIG. 13) due to the laser irradiation process in the axially symmetrical directions with respect to the four axes x. Then, the spiral configuration is made to be rotative with respect to the liquid discharge direction, while the circular form gradually changes substantially to the square form in the thickness direction of the discharge port plate 2.

Also, each discharge port 21 of the discharge port plate 2 thus processed and formed is substantially square on the liquid supply side, and the sectional area of the ink flow path is also square in the ink flow direction. Here, the discharge ports 21 are laser processed to form them to fit into each other to make ink flow path configuration smoothly continuous. In this manner, the flow resistance to the recording liquid is reduced to make the flying speed of ink faster, hence demonstrating the effect that the quality of the ink jet head is enhanced, such as to provide the higher speed of printing.

For the specific embodiment of the present invention, the polysulfone discharge port plate of 50 μm thick is bonded to the ink jet head main body. After that, the mask plate having 150 apertures of 20 μm Φ each arranged in a density of 300 dpi is placed closely in contact with the discharge port plate with the beam reflection rate of 98% or more in the wavelength of the irradiated laser. Then, using the aforesaid optical system (FIG. 9) the four parallel beams are irradiated to the mask plate at the laser power of 1 J/cm². Here, the closely contacted mask plate 1, discharge port plate 2, and ink jet head main body 3 is rotated at an angle of 20° in the initiation and the termination of the processing to form the discharge ports. Also, the inclination angle at that time is arranged to be 13° to the axial direction of liquid discharges. In this manner, 50 pieces of the heads are produced in order to observe the discharge port configuration. As a result, it is found that everyone of them has a tapered configuration having the thinner leading end on the liquid discharge side. Also, the fluctuation of the aperture diameter of each of the discharge ports on the liquid discharge side is made significantly smaller than the conventional ones.

Also, the actual printing is performed with the ink jet heads thus manufactured. Then, images are obtained with excellent print quality which presents the clear circle in each form of the printed dots having an extremely smaller amount of mists.

(Fourth Embodiment)

Now, hereunder, a fourth embodiment will be described in accordance with the present invention.

For an ink jet head, a water repellent layer is often formed in order to prevent the discharge port plate from being stained by ink. Then, if the discharge ports are processed from the outer side of the discharge port plate, which is on the ink discharge side, in a state where the water repellent layer is formed for the discharge port plate after the ink jet head has been assembled, the water repellency tends to be deteriorated by the irradiation of laser which may decompose the water repellent material coated on the layer on the outer surface of the discharge port plate. Also, if there is any portion where the mask plate is not closely in contact with the discharge port plate, a problem is encountered that the edge of the discharge ports on the ink discharge side tends to sag on such portion due to a slight optical blurring on the outer circumference of the laser irradiated pattern.

Here, therefore, the sharpness of the ink discharging edge is extremely important in order to maintain the ink cutting effect at the time of ink discharges and stably orientate the flying direction of the ink droplets. Here, if the edge is allowed to sag, a problem is inevitably encountered that the erroneous impact positions of the ink droplets take place or the ink droplets are caused to spread (the misty discharges).

Also, the by-products created by the processing are allowed to spread even to the ink flow paths of an ink jet head, and the spreading debris may exert influence on the ink flow due to the surface energy and hydrophilic property thereof or it may adhere to the heat generating elements that generate ink discharge energy and contaminates them to lower the heat generating efficiency.

Therefore, the present embodiment proposes the method for forming the ink discharge edge of the discharge ports sharply on the outer side of the discharge port plate, while causing any damages to the water repellent layer on the outer side of the discharge port plate. At the same time, the present embodiment is aimed at removing debris which is the spreading by-products in the ink flow paths.

Now, hereunder, with reference to FIG. 14, the present embodiment will be described in detail.

The method for processing the discharge ports of an ink jet head in accordance with the fourth embodiment of the present invention is, as shown in FIG. 14, an sacrificing layer 5 is closely bonded to the ink jet head in the state where the discharge port plate 2 is bonded and assembled with the ink jet head main body 3. Then, the mask plate 1 having the opening of the discharge port pattern 11 on it is closely in contact through the sacrificing layer 5. The ultraviolet laser beams are irradiated in the direction inclined to the vertical line of the mask plate 1 to form a plurality of nozzles 21 simultaneously in the tapered configuration which is thinner in the ink discharge direction (the mask plate side) by performing the ablation processing in each of the laser beam advancing direction in the thickness direction of the discharge port plate 2 formed by the organic polymer resin.

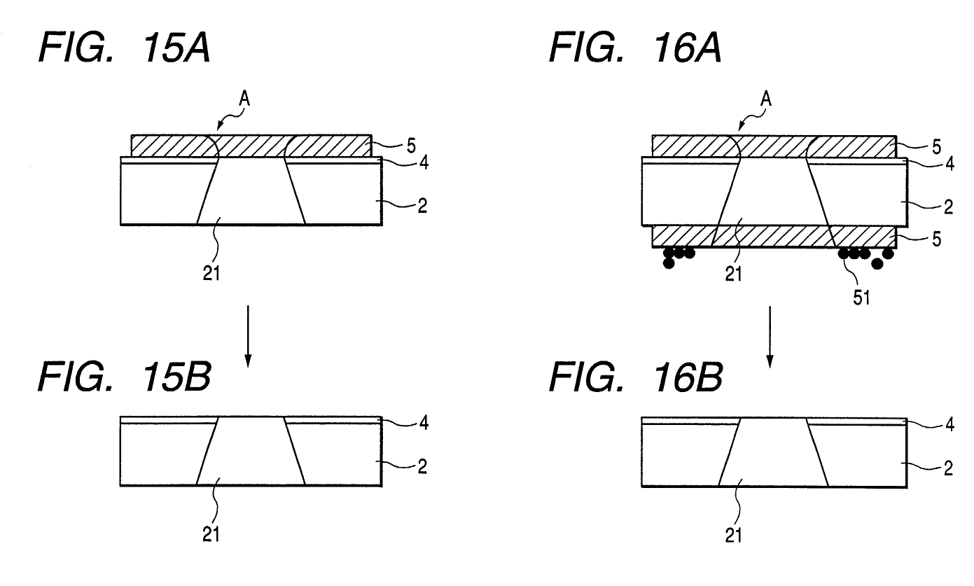

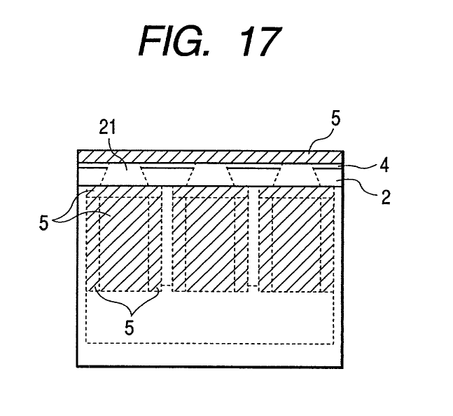

At this juncture, the sacrificing layer 5 formed by resin material is ablated together with the material of the discharge port plate by the irradiation of laser beams at the same time, hence processing to form the discharge ports 21. However, with this processing method, the process sagging portion is created at A in FIG. 15A due to the fusion phenomenon caused by the heat accumulation of the laser irradiation. If each of the discharge ports is formed as it is with the presence of the sagging portion thus created, there is a problem encountered that not only ink is not allowed to fly exactly, but also, fine mist is caused to occur when ink flies. However, in accordance with the present embodiment, the sacrificing layer 5 formed by the soluble resin material is cleaned for removal after completing the processing of the discharge ports 21 by the irradiation of laser beams. Therefore, as shown in FIG. 15B, the sagging portion is removed to make the edge of each discharge port is formed sharply. Also, when the discharge ports are processed by the application of laser beams, the debris is created as its by-products. If the debris spreads to adhere to the ink flow paths, the ink flow is affected or if it adheres to the heat generating elements that generate ink discharge energy, the elements are contaminated to lower its heat generating efficiency in some cases. As shown in FIG. 17, therefore, the sacrificing layer 5 is attached to the inner side of the discharge port plate or the outer wall face of the ink flow paths as in the case of its attachment to the outer face of the discharge port plate. Then, the debris is caused to adhere to the sacrificing layer when the discharge ports are processed. In this manner, the debris is removed by removing the sacrificing layer 5 after the processing.

This method for removing the debris is also effective even when the discharge ports are processed to be formed with the discharge port plate as a single body. As shown in FIGS. 16A and 16B, the sacrificing layers 5 is attached to the laser beam incident face of the discharge plate 3, as well as to the reverse side thereof. Then, with the laser being irradiated for processing, the edge of the discharge ports at A are formed sharply on the outer face (surface) of the discharge port plate 3, and also, the water repellent film 4 is protected. On the inner face (reverse side) thereof, the by-products, debris 51 are removed together with the sacrificing layer 5.

For the ink jet head having the discharge ports 21 formed as described above, the edge of the discharge ports 21 on the discharge port plate 2 is formed sharply on the ink discharge side to make it possible to cut ink at the time of ink discharges. Thus, errors seldom occur in the discharge direction due to the surface tension of ink. Also, the generation of ink mist becomes almost none when ink is cut. As a result, the print quality is enhanced significantly.

(Fifth Embodiment)

Now, hereunder, a fifth embodiment will be described in accordance with the present invention.

In general, the light beam used for the laser processing has the distribution of intensity. Then, if the irradiation area of the light beam is arranged to be extremely wide, the apparatus should be made larger itself, although the influence that may be exerted by the intensity distribution. With the productivity in view, therefore, it is not very advisable to arrange the wide irradiation area. However, if the influence of the luminous intensity distribution of the light beam is greater, a problem is encountered that it is impossible to configure a plurality of discharge ports uniformly. Here, the present embodiment is proposed to aim at the provision of a method for processing all the discharge ports in an even configuration without making the apparatus larger even when the distribution of the luminous intensity of the light beam has a strong influence, thus making it possible to allow the liquid ink droplets to fly stably and exactly for the performance of the high quality printing.

Now, with reference to the accompanying drawings, the detailed description will be made of the method for processing the discharge ports in accordance with the present embodiment which is a principle part of the present invention.

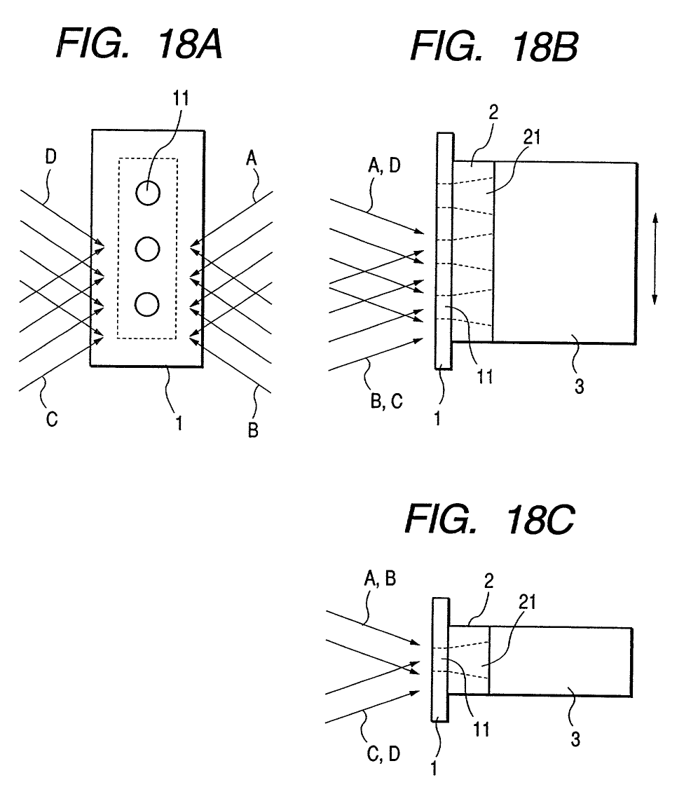

FIGS. 18A to 18C are views which schematically illustrate the method for processing the discharge ports of an ink jet head in accordance with the present embodiment.

In FIGS. 18A to 18C, the discharge ports 21 are formed by the irradiation of the ultraviolet laser beams A, B, C, and D from the ink discharge side onto the discharge port plate 2 bonded to be assembled in the ink jet head main body 3. The laser beams A, B, C, and D are inclined, respectively, in the different directions to the vertical line of the mask plate 1 with the opening of the discharge port pattern 11, which is closely in contact with the discharge port plate 2 in advance. The overlapping positions of the laser beams A, B, C, and D are specified on the mask plate 1 portion.

In this respect, the detailed description will be made of each direction of the laser beams A, B., C, and D irradiated to the mask plate. Now, given the xyz coordinate system set as shown in FIG. 2, each of the laser beams forms an angle of 45° (90° to each of the laser beams themselves) to the axis y (the arrangement direction of the discharge ports 21) in the plane projection of y and z, which is defined as the standard condition, and each of them is irradiated in the direction that forms the same inclination angle θ to the axis x (in the vertical direction of the mask plate 1), that is, in the directions shown in FIG. 3. Here, the θ is set at an angle of approximately 5° to 20°, although the angle is set depending on the thickness of the discharge port plate 2 to be processed, as well as on the energy concentration of the laser beams to be applied when the angle is designed. In accordance with the present embodiment, this angle is set at 13°.

For the present embodiment, the discharge port plate 2 and ink jet head main body 3 with which the mask plate 1 is closely in contact are allowed to reciprocate altogether in the directions indicated by arrows in FIG. 18A from the initiation and the termination of the processing. This reciprocative movement means that after the discharge port plate 2 and ink jet head main body 3 with which the mask plate 1 is closely in contact are relatively carried from the outside the laser irradiating area to outside the laser irradiating area on the opposite side, these members are allowed to be carried likewise in the opposite direction.

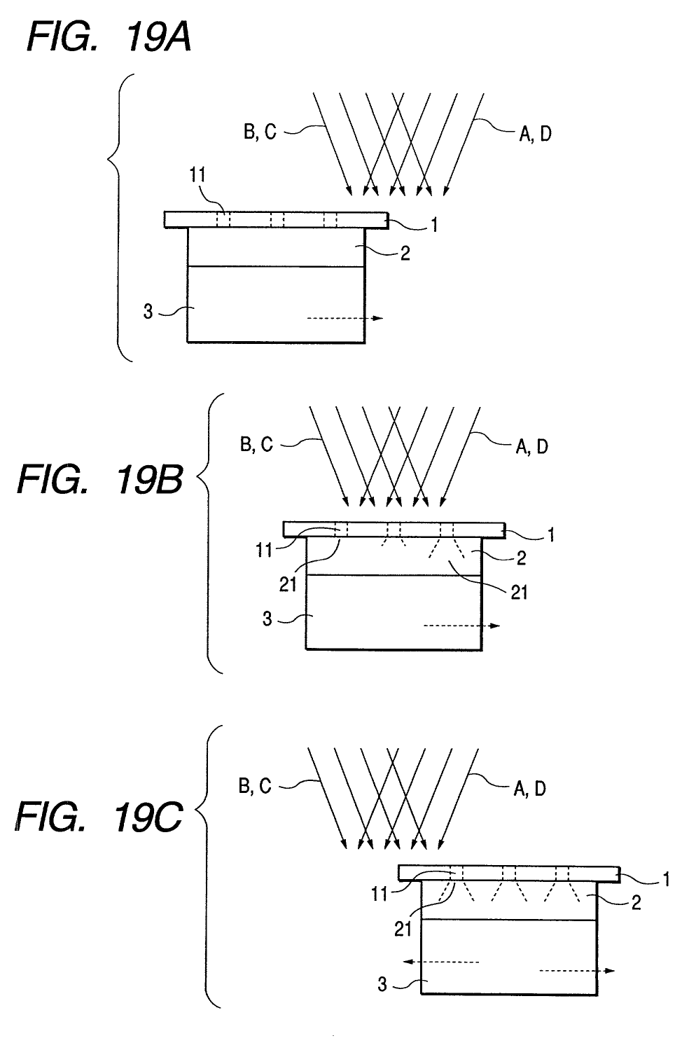

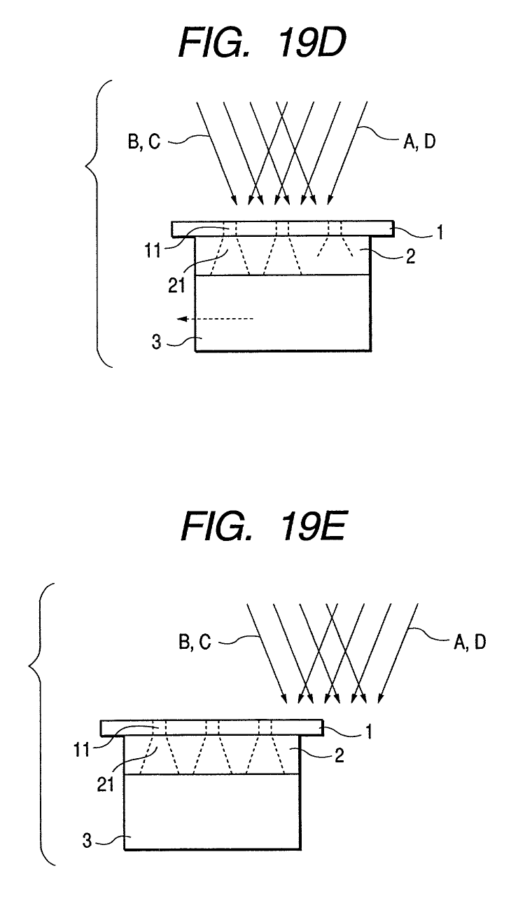

Now, in conjunction with FIGS. 19A to 19E, the detailed description will be made of each state in which the process is in progress.

At first, the discharge port plate 2 and ink jet head main body 3 with which the mask plate 1 is closely in contact are carried from outside the laser irradiating area in the same direction as the arrangement direction of the discharge ports (from the left to the right in FIGS. 19A to 19E) (FIG. 19A), and the discharge port is processed to be formed when passing the laser irradiating area (FIG. 19B), and then, when carried as it is to the outside of the laser irradiating area (FIG. 19C), these members are carried in the opposite direction (from the right to the left in FIGS. 19A to 19E) to pass the laser irradiating area again where the discharge port portion is processed (FIG. 19D). Thus, when carried to the outside of the laser irradiating area, all the discharge ports are formed (FIG. 19E). In this manner, with the relative movement of the discharge port plate 2 and ink jet head main body 3 having the mask plate 1 to be closely in contact with them to enable them to reciprocate in the laser irradiating area, it is made possible to irradiate the ultraviolet laser for processing the discharge ports evenly for each of them to be processed and formed by means of the integral effect acting upon the uneven distribution of the laser irradiation, hence processing to form the discharge ports uniformly. In this respect, it is arranged for the present embodiment to set the carrier speed so that the pulse numbers of laser just fit for the formation of the discharge ports by one reciprocation. However, it may be possible to set the carrier speed so that the pulse numbers of laser just fit for the formation of the discharge ports by several reciprocation. Also, the movement of the discharge plate 2 and ink jet head main body 3 with which the mask plate is closely in contact may be arranged to be continuous or executable in stepwise. Here, if only the same number of laser pulses is irradiated onto each of the discharge ports when a specific reciprocative movement is completed, the movement may be arranged anyway.

Each of the discharge ports 21 thus processed is not in the conical form cut in the rotation symmetry, but it is configured to be conical on the recording liquid discharge side (on the front side in FIGS. 19A to 19E) and almost square formed by the four circles overlaid radially on the recording liquid supply side (in the depth side in FIGS. 19A to 19E) due to the laser irradiation process in the axially symmetrical directions with respect to the four axes x.

As described above, in accordance with the present embodiment, the ultraviolet laser parallel beams A, B, C, and D are irradiated at the same time in the four directions, while the closely contacted mask plate 1, discharge port 2, and ink jet head main body 3 are allowed to reciprocate with respect to the laser irradiation, hence making it possible to from a plurality of discharge ports 21 having the tapered configuration becoming thinner in the ink discharge direction (on the mask plate side) with all the discharge ports uniformly configured.

For the present embodiment, the polysulfone discharge port plate of 50 μm thick is bonded to the ink jet head main body. After that, the mask plate having 150 apertures of 20 μm Φ each arranged in a density of 300 dpi is placed closely in contact with the discharge port plate with the beam reflection rate of 98% or more in the wavelength of the irradiated laser. Then, using the aforesaid optical system the four parallel beams are irradiated to the mask plate at the laser power of 1 J/cm². Here, the closely contacted mask plate 1, discharge port plate 2, and ink jet head main body 3 are allowed to reciprocate twice for scanning by the laser beams irradiated thereon at the initiation and termination of processing to form the discharge ports. Also, the inclination angle at that time is arranged to be 13° to the axial direction of liquid discharges. In this manner, 50 pieces of the heads are produced in order to observe the discharge port configuration. As a result, it is found that everyone of them has a tapered configuration having the thinner leading end on the liquid discharge side. Also, the fluctuation of the aperture diameter of each of the discharge ports on the liquid discharge side is made significantly smaller than the conventional ones.

Also, the actual printing is performed with the ink jet heads thus manufactured. Then, images are obtained with excellent print quality which presents the clear circle in each form of the printed dots having an extremely smaller amount of mists.

What is claimed is:

1. A method for processing a discharge ports of an ink jet head provided with the discharge port for discharging ink and a discharge port plate having said discharge port, comprising the following steps of:
closely contacting the mask plate having opening in the form of said discharge port with the face of the said discharge port plate on the ink discharge side; and
forming said discharge port on said discharge port plate by irradiating plural high energy ultraviolet parallel beams simultaneously through said mask plate in the direction inclined at a specific angle to the vertical axis of the mask plate face.

2. A method for processing the discharge port of an ink jet head according to claim 1, wherein the irradiation of the plural high energy ultraviolet parallel beams is incident upon in the direction inclined at the same angle to the vertical axis of the mask plate.

3. A method for processing the discharge port of an ink jet head according to claim 1, wherein the irradiation of the plural high energy ultraviolet parallel beams is incident upon in the direction equally divided with respect to the circumferential directions of the mask plate.

4. A method for processing the discharge port of an ink jet head according to claim 1, wherein the high energy ultraviolet parallel beams are formed by two beams, and each of the beams is inclined at a specific angle symmetrical to the vertical axis of the mask plate, and then, irradiated in the direction at right angles to the arrangement direction of the discharge port.

5. A method for processing the discharge port of an ink jet head according to claim 1, wherein the high energy ultraviolet parallel beams are formed by four beams, and each of the beams is inclined at a specific angle to the vertical axis of the mask plate, and then, irradiated in the direction equally divided with respect to the circumferential directions of the vertical axis and in the direction at an angle of 45° to the arrangement direction of the discharge port.

6. A method for manufacturing an ink jet head provided with discharge port for discharging ink and a discharge port plate having said discharge port, comprising the following steps of:
closely contacting the mask plate having opening in the form of said discharge port with the face of the said discharge port plate on the ink discharge side; and
forming said discharge port on said discharge port plate by irradiating plural high energy ultraviolet parallel beams simultaneously through said mask plate in the direction inclined at a specific angle to the vertical axis of the mask plate face.

7. A method for manufacturing an ink jet head according to claim 6, wherein said discharge port formation step is performed after said discharge port plate is bonded to the ink jet head main body.

8. A method for manufacturing an ink jet head according to claim 6, wherein the irradiation of the plural high energy ultraviolet parallel beams is incident upon in the direction inclined at the same angle to the vertical axis of the mask plate.

9. A method for manufacturing an ink jet head according to claim 6, wherein the irradiation of the plural high energy ultraviolet parallel beams is incident upon in the direction equally divided with respect to the circumferential directions of the mask plate.

10. A method for manufacturing an ink jet head according to claim 6, wherein the high energy ultraviolet parallel beams are formed by two beams, and each of the beams is inclined at a specific angle symmetrical to the vertical axis of the mask plate, and then, irradiated in the direction at right angles to the arrangement direction of the discharge port.

11. A method for manufacturing an ink jet head according to claim 6, wherein the high energy ultraviolet parallel beams are formed by four beams, and each of the beams is inclined at a specific angle to the vertical axis of the mask plate, and then, irradiated in the direction equally divided with respect to the circumferential directions of the vertical axis and in the direction at an angle of 45° to the arrangement direction of the discharge port.

12. A method for manufacturing an ink jet head according to claim 11, wherein said ink jet head is provided with an ink flow paths communicated with said ink discharge port, each having the rectangular section, and said discharge port is arranged on the end portion of said ink flow path.

13. A method for manufacturing an ink jet head according to claim 6, wherein said discharge port plate is formed by resin.

14. A method for manufacturing an ink jet headccording to claim 6, wherein said discharge port plate is formed by silicon nitride.

15. A method for manufacturing an ink jet head according to claim 6, wherein said high energy ultraviolet parallel beams are formed by the higher harmonic wave of excimer laser or YAG laser.

16. A method for processing the discharge port of an ink jet head according to claim 1, wherein said closely contacted mask plate and said discharge port plate are rotated around said vertical axis with said vertical axis as the rotational axis thereof.

17. A method for manufacturing an ink jet head according to claim 6, wherein said closely contacted mask plate and said discharge port plate are rotated around said vertical axis with said vertical axis as the rotational axis thereof.

18. A method for processing the discharge port of an ink jet head according to claim 1, wherein after a sacrificing layer formed by a material processible by said high energy ultraviolet parallel bemas is closely contacted with the outer face of said discharge port plate, the high energy ultraviolet parallel beams are irradiated onto said discharge port plate through said mask plate, and then, said sacrificing layer is peeled to be removed by a chemical or physical method.

19. A method for processing the discharge port of an ink jet head according to claim 1, wherein after a sacrificing layer formed by a material processible by said high energy ultraviolet parallel bemas is closely contacted with the outer face and the inner face of said discharge port plate, the high energy ultraviolet parallel beams are irradiated onto said discharge port plate through said mask plate, and then, said sacrificing layer is peeled to be removed by a chemical or physical method.

20. A method for processing the discharge port of an ink jet head according to claim 18 or claim 19, wherein said sacrificing layer is formed by coating water soluble resin on the discharge port plate, and the sacrificing layer is removed by washing after the discharge port is formed.

21. A method for processing the discharge port of an ink jet head according to claim 18 or claim 19, wherein said sacrificing layer is formed by thin resin film adhering to the discharge port plate in vacuum, and the sacrificing layer is removed by mechanically peeled off after the discharge port is formed.

22. A method for manufacturing an ink jet head according to claim 1, wherein after a sacrificing layer formed by a material processible by said high energy ultraviolet parallel bemas is closely contacted with the outer face of said discharge port plate, the high energy ultraviolet parallel beams are irradiated onto said discharge port plate through said mask plate, and then, said sacrificing layer is peeled to be removed by a chemical or physical method.

23. A method for manufacturing an ink jet head according to claim 1, wherein after a sacrificing layer formed by a material processible by said high energy ultraviolet parallel bemas is closely contacted with the outer face and the inner face of said discharge port plate, the high energy ultraviolet parallel beams are irradiated onto said discharge port plate through said mask plate, and then, said sacrificing layer is peeled to be removed by a chemical or physical method.

24. A method for manufacturing an ink jet head according to claim 22 or claim 23, wherein said sacrificing layer is formed by coating water soluble resin on the discharge port plate, and the sacrificing layer is removed by washing after the discharge port is formed.

25. A method for manufacturing an ink jet head according to claim 22 or claim 23, wherein said sacrificing layer is formed by thin resin film adhering to the discharge port plate in vacuum, and the sacrificing layer is removed by mechanically peeled off after the discharge port is formed.

26. A method for processing the discharge port of an ink jet head according to claim 1, wherein for said discharge port plate, a plurality of said discharge port are one dimensionally arranged or the arrangement of plural discharge port is made in plural lines for formation, and said closely contacted mask plate and said discharge plate perform one or more reciprocative scannings with respect to the irradiating area of the high energy ultraviolet beams.

27. A method for processing the discharge port of an ink jet head according to claim 26, wherein said reciprocative operations are performed continuously.

28. A method for processing the discharge port of an ink jet head according to claim 26, wherein said reciprocative operations are performed stepwise.

29. A method for manufacturing an ink jet head according to claim 6, wherein for said discharge port plate, a plurality of said discharge port is one dimensionally arranged or the arrangement of plural discharge port is made in plural lines for formation, and said closely contacted mask plate and said discharge plate perform one or more reciprocative scannings with respect to the irradiating area of the high energy ultraviolet beams.

30. A method for manufacturing an ink jet head according to claim 29, wherein said reciprocative operations are performed continuously.

31. A method for manufacturing an ink jet head according to claim 29, wherein said reciprocative operations are performed stepwise.
